(19) United States
(12) Patent Application Publication
(10) Pub. No.: US 2003/0232140 A1
(43) Pub. Date: Dec. 18, 2003

(54) Methods for reagent removal in flow chambers

(76) Inventors: Joseph Remick, Milpitas, CA (US); Anthony J.D. Feurtado, San Jose, CA (US); Maryam Mobed-Miremadi, Sunnyvale, CA (US); Tim J. Lazaruk, Redwood City, CA (US); Jay K. Bass, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/172,470

(22) Filed: Jun. 14, 2002

(51) Int. Cl. B05D 3/00

(52) U.S. Cl. 427/294

(57) ABSTRACT

Methods and apparatus are disclosed for synthesizing a plurality of compounds on the surface of supports. Biopolymer features are attached to the surfaces of the supports. The synthesis generally comprises a plurality of steps. The support is placed into a flow chamber, and a reagent is introduced into the flow chamber. The reagent is reactive with features on the surface of the support. During removal of the reagent from the flow chamber, the pressure in the chamber is maintained substantially atmospheric. In another embodiment the reagent is removed from the flow chamber under vacuum. In another embodiment the reagent is removed from the flow chamber by simultaneously venting and applying a vacuum to the flow chamber.

### BACKGROUND OF THE INVENTION

This invention relates to the manufacturing of supports having bound to the surfaces thereof a plurality of chemical compounds such as polymers, which are prepared on the surface in a series of steps. More particularly, the present invention relates to methods and apparatus for solid phase chemical synthesis, particularly solid phase synthesis of oligomer arrays, or attachment of oligonucleotides and polynucleotides to surfaces, e.g., arrays of polynucleotides, where one or more flow cells or chambers are employed.

In the field of diagnostics and therapeutics, it is often useful to attach species to a surface. One important application is in solid phase chemical synthesis wherein initial derivatization of a substrate surface enables synthesis of polymers such as oligonucleotides and peptides on the substrate itself. Support bound oligomer arrays, particularly oligonucleotide arrays, may be used in screening studies for determination of binding affinity. Modification of surfaces for use in chemical synthesis has been described. See, for example, U.S. Pat. No. 5,624,711 (Sundberg), U.S. Pat. No. 5,266,222 (Willis) and U.S. Pat. No. 5,137,765 (Farnsworth).

Determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe. Hybridization is based on complementary base pairing. When complementary single stranded nucleic acids are incubated together, the complementary base sequences pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Direct detection of labeled target nucleic acid hybridized to surface-bound polynucleotide probes is particularly advantageous if the surface contains a mosaic of different probes that are individually localized to discrete, known areas of the surface. Such ordered arrays containing a large number of oligonucleotide probes have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be used for conducting cell study, for diagnosing disease, identifying gene expression, monitoring drug response, determination of viral load, identifying genetic polymorphisms, analyze gene expression patterns or identify specific allelic variations, and the like.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective binding to matching probe sites takes place. The array is then washed and interrogated to determine the extent of hybridization reactions. In one approach the array is imaged so as to reveal for analysis and interpretation the sites where binding has occurred. Arrays of different chemical probe species provide methods of highly parallel detection, and hence improved speed and efficiency, in assays. Assuming that the different sequence polynucleotides were correctly deposited in accordance with the predetermined configuration, then the observed binding pattern will be indicative of the presence and/or concentration of one or more polynucleotide components of the sample.

The arrays may be microarrays created by in-situ synthesis, oligonucleotide deposition or cDNA. In general, arrays are synthesized on a surface of a substrate by one of any number of synthetic techniques that are known in the art. In one approach to the synthesis of microarrays, flow chambers or flow cells or flow devices are employed in which a substrate is placed to carry out the synthesis. After the substrate is placed in the flow chamber, reagent is introduced into the chamber by an inlet. The reagent is held in the chamber for a predetermined period of time. Subsequently, the flow chamber is drained by opening an outlet valve and pressurizing the chamber with an inert gas to force out the liquid.

There is a need for a method for introducing and removing reagents to and from flow chambers where the method minimizes the potential for leaks in the flow chamber, reduces stress on the substrate, and provides for more efficient removal of reagent from the flow chamber. Preferably, the method permits enhanced drying time for the substrate after features on its surface have been exposed to reagent in the flow chamber and liquid has been removed from the flow chamber.

### SUMMARY OF THE INVENTION

One embodiment of the present invention is a method for conducting reactions on the surface of a support in a flow chamber. The support is placed into the flow chamber, and a reagent is introduced into the flow chamber. The reagent is reactive with features on the surface of the support. During removal of the reagent from the flow chamber, the pressure in the chamber is maintained substantially atmospheric. In another embodiment the reagent is removed from the flow chamber under vacuum. In another embodiment the reagent is removed from the flow chamber by simultaneously venting and applying a vacuum to the flow chamber.

Another embodiment of the present invention is a method for synthesizing a plurality of biopolymers on the surface of a support. The method comprises placing the support into a reaction chamber and applying to the surface the biopolymers or precursors of the biopolymers. The support is removed from the reaction chamber and placed in a flow chamber. A reagent for conducting the synthesis is introduced into the flow chamber. The reagent is then removed from the flow chamber while the pressure in the chamber is maintained substantially atmospheric during the removing. The support is removed from the flow chamber. The steps above are repeated a sufficient number of times to form the plurality of biopolymers on the surface of the support. In one embodiment the synthesis comprises a plurality of monomer additions and the above steps are carried out after each of the monomer additions.

Another embodiment of the present invention is a flow cell assembly for conducting at least one reaction in the synthesis of an array of biopolymers on the surface of a support. The flow cell assembly comprises a flow cell chamber, a manifold in fluid communication with the chamber, and a vacuum source in fluid communication with the flow cell chamber. The manifold comprising at least 3 inlets, a wash reagent inlet, an inlet for a reagent for conducting a step of said synthesis, and a vent. The flow cell assembly may also comprise a fluid level sensor and a controller for controlling the inlets, the vent and the vacuum source. One or more of the flow cell assemblies may be part of an apparatus for synthesizing an array of biopolymers on the surface of a support.

### BRIEF DESCRIPTION OF THE DRAWINGS

FIG. 1 is a schematic diagram depicting a flow cell assembly in accordance with the present invention.

FIG. 2 is a schematic diagram depicting an embodiment of an apparatus for conducting synthesis of biopolymers on the surface of a support wherein the apparatus comprises the flow cell assembly of FIG. 1.

### DETAILED DESCRIPTION OF THE INVENTION

The present methods may be employed in the synthesis of a plurality of chemical compounds on supports with particular application to such synthesis on a commercial scale. Usually, the chemical compounds are those that are synthesized in a series of steps such as, for example, the addition of building blocks, which are chemical components of the chemical compound. Examples of such building blocks are those found in the synthesis of polymers. The methods to which the present invention has application generally are those that employ one or more flow cells or chambers, in a different repetitive step in the synthesis of the chemical compounds is conducted. In general, the support is placed in the flow cell, which is then filled with a reagent for carrying out the particular step of the synthesis. The reagent is usually held in the flow cell for a time sufficient for the reagents to interact with the materials on the surface of the support. In accordance with the present invention, reagent is removed from the flow cell at a pressure that does not substantially exceed atmospheric pressure. This may be accomplished by simultaneously venting and applying a vacuum to the flow chamber.

As mentioned above, the chemical compounds are those that are synthesized in a series of steps, which usually involve linking together building blocks that form the chemical compound. The invention has particular application to the synthesis of oligomers or polymers. The oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure. Exemplary of oligomers are oligonucleotides and peptides.

A monomer is a chemical entity that can be covalently linked to one or more other such entities to form an oligomer or polymer. Examples of monomers include nucleotides, amino acids, saccharides, peptoids, and the like and subunits comprising nucleotides, amino acids, saccharides, peptoids and the like. The subunits may comprise all of the same component such as, for example, all of the same nucleotide or amino acid, or the subunit may comprise different components such as, for example, different nucleotides or different amino acids. The subunits may comprise about 2 to about 2000, or about 5 to about 200, monomer units. In general, the monomers have first and second sites (e.g., C-termini and N-termini, or 5′ and 3′ sites) suitable for binding of other like monomers by means of standard chemical reactions (e.g., condensation, nucleophilic displacement of a leaving group, or the like), and a diverse element that distinguishes a particular monomer from a different monomer of the same type (e.g., an amino acid side chain, a nucleotide base, etc.). The initial substrate-bound, or support-bound, monomer is generally used as a building block in a multi-step synthesis procedure to form a complete ligand, such as in the synthesis of oligonucleotides, oligopeptides, oligosaccharides, etc. and the like.

A biomonomer references a single unit, which can be linked with the same or other biomonomers to form a biopolymer (for example, a single amino acid or nucleotide with two linking groups one or both of which may have removable protecting groups). A biomonomer fluid or biopolymer fluid reference a liquid containing either a biomonomer or biopolymer, respectively (typically in solution).

A biopolymer is a polymer of one or more types of repeating units. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. The oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

A nucleotide refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

The support to which a plurality of chemical compounds is attached is usually a porous or non-porous water insoluble material. The support can have any one of a number of shapes, such as strip, plate, disk, rod, particle, and the like. The support can be hydrophilic or capable of being rendered hydrophilic or it may be hydrophobic. The support is usually glass such as flat glass whose surface has been chemically activated to support binding or synthesis thereon, glass available as Bioglass and the like. However, the support may be made from materials such as inorganic powders, e.g., silica, magnesium sulfate, and alumina; natural polymeric materials, particularly cellulosic materials and materials derived from cellulose, such as fiber containing papers, e.g., filter paper, chromatographic paper, etc.; synthetic or modified naturally occurring polymers, such as nitrocellulose, cellulose acetate, poly (vinyl chloride), polyacrylamide, cross linked dextran, agarose, polyacrylate, polyethylene, polypropylene, poly(4-methylbutene), polystyrene, polymethacrylate, poly(ethylene terephthalate), nylon, poly(vinyl butyrate), etc.; either used by themselves or in conjunction with other materials; ceramics, metals, and the like. Preferably, for packaged arrays the support is a non-porous material such as glass, plastic, metal and the like.

The surface of a support is normally treated to create a primed or functionalized surface, that is, a surface that is able to support the synthetic steps involved in the production of the chemical compound. Functionalization relates to modification of the surface of a support to provide a plurality of functional groups on the support surface. By the term “functionalized surface” is meant a support surface that has been modified so that a plurality of functional groups are present thereon. The manner of treatment is dependent on the nature of the chemical compound to be synthesized and on the nature of the support surface. In one approach a reactive hydrophilic site or reactive hydrophilic group is introduced onto the surface of the support. Such hydrophilic moieties can be used as the starting point in a synthetic organic process.

In one embodiment, the surface of the support, such as a glass support, is siliceous, i.e., comprises silicon oxide groups, either present in the natural state, e.g., glass, silica, silicon with an oxide layer, etc., or introduced by techniques well known in the art. One technique for introducing siloxyl groups onto the surface involves reactive hydrophilic moieties on the surface. These moieties are typically epoxide groups, carboxyl groups, thiol groups, and/or substituted or unsubstituted amino groups as well as a functionality that may be used to introduce such a group such as, for example, an olefin that may be converted to a hydroxyl group by means well known in the art. One approach is disclosed in U.S. Pat. No. 5,474,796 (Brennan), the relevant portions of which are incorporated herein by reference. A siliceous surface may be used to form silyl linkages, i.e., linkages that involve silicon atoms. Usually, the silyl linkage involves a silicon-oxygen bond, a silicon-halogen bond, a silicon-nitrogen bond, or a silicon-carbon bond.

Another method for attachment is described in U.S. Pat. No. 6,219,674 (Fulcrand, et al.). A surface is employed that comprises a linking group consisting of a first portion comprising a hydrocarbon chain, optionally substituted, and a second portion comprising an alkylene oxide or an alkylene imine wherein the alkylene is optionally substituted. One end of the first portion is attached to the surface and one end of the second portion is attached to the other end of the first portion chain by means of an amine or an oxy functionality. The second portion terminates in an amine or a hydroxy functionality. The surface is reacted with the substance to be immobilized under conditions for attachment of the substance to the surface by means of the linking group.

Another method for attachment is described in U.S. Pat. No. 6,258,454 (Lefkowitz, et al.). A solid support having hydrophilic moieties on its surface is treated with a derivatizing composition containing a mixture of silanes. A first silane provides the desired reduction in surface energy, while the second silane enables functionalization with molecular moieties of interest, such as small molecules, initial monomers to be used in the solid phase synthesis of oligomers, or intact oligomers. Molecular moieties of interest may be attached through cleavable sites.

A procedure for the derivatization of a metal oxide surface uses an aminoalkyl silane derivative, e.g., trialkoxy 3-aminopropylsilane such as aminopropyltriethoxy silane (APS), 4-aminobutyltrimethoxysilane, 4-aminobutyltriethoxysilane, 2-aminoethyltriethoxysilane, and the like. APS reacts readily with the oxide and/or siloxyl groups on metal and silicon surfaces. APS provides primary amine groups that may be used to carry out the present methods. Such a derivatization procedure is described in EP 0 173 356 B1, the relevant portions of which are incorporated herein by reference. Other methods for treating the surface of a support will be suggested to those skilled in the art in view of the teaching herein.

The apparatus and methods of the present invention are particularly useful in the synthesis of arrays of biopolymers. An array includes any one, two or three dimensional arrangement of addressable regions bearing a particular chemical moiety or moieties such as, for example, biopolymers, e.g., one or more polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

The present methods and apparatus may be used in the synthesis of polypeptides. The synthesis of polypeptides involves the sequential addition of amino acids to a growing peptide chain. This approach comprises attaching an amino acid to the functionalized surface of the support. In one approach the synthesis involves sequential addition of carboxyl-protected amino acids to a growing peptide chain with each additional amino acid in the sequence similarly protected and coupled to the terminal amino acid of the oligopeptide under conditions suitable for forming an amide linkage. Such conditions are well known to the skilled artisan. See, for example, Merrifield, B. (1986), Solid Phase Synthesis, Sciences 232, 341-347. After polypeptide synthesis is complete, acid is used to remove the remaining terminal protecting groups. Each of the repetitive steps involved in the addition of an amino acid may be carried out in one or more flow cells. Such repetitive steps may involve, among others, washing of the surface, protection and deprotection of certain functionalities on the surface, oxidation or reduction of functionalities on the surface, and so forth.

The present invention has particular application to the synthesis of arrays of chemical compounds on a surface of a support. Typically, methods and apparatus of the present invention generate or use an array assembly that may include a support carrying one or more arrays disposed along a surface of the support and separated by inter-array areas. Normally, the surface of the support opposite the surface with the arrays does not carry any arrays. The arrays can be designed for testing against any type of sample, whether a trial sample, a reference sample, a combination of the foregoing, or a known mixture of components such as polynucleotides, proteins, polysaccharides and the like (in which case the arrays may be composed of features carrying unknown sequences to be evaluated). The surface of the support may carry at least one, two, four, or at least ten, arrays. Depending upon intended use, any or all of the arrays may be the same or different from one another and each may contain multiple spots or features of chemical compounds such as, e.g., biopolymers in the form of polynucleotides or other biopolymer. A typical array may contain more than ten, more than one hundred, more than one thousand or ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features and each array may be separated by spaces or areas. It will also be appreciated that there need not be any space separating arrays from one another. Interarray areas and interfeature areas are usually present but are not essential. These areas do not carry any chemical compound such as polynucleotide (or other biopolymer of a type of which the features are composed). Interarray areas and interfeature areas typically will be present where arrays are formed by the conventional in situ process or by deposition of previously obtained moieties, as described above, by depositing for each feature at least one droplet of reagent such as from a pulse jet (for example, an inkjet type head) but may not be present when, for example, photolithographic array fabrication processes are used. It will be appreciated though, that the interarray areas and interfeature areas, when present, could be of various sizes and configurations.

The devices and methods of the present invention are particularly useful in the synthesis of oligonucleotide arrays for determinations of polynucleotides. As explained briefly above, in the field of bioscience, arrays of oligonucleotide probes, fabricated or deposited on a surface of a support, are used to identify DNA sequences in cell matter. The arrays generally involve a surface containing a mosaic of different oligonucleotides or sample nucleic acid sequences or polynucleotides that are individually localized to discrete, known areas of the surface. In one approach, multiple identical arrays across a complete front surface of a single substrate or support are used.

Ordered arrays containing a large number of oligonucleotides have been developed as tools for high throughput analyses of genotype and gene expression. Oligonucleotides synthesized on a solid support recognize uniquely complementary nucleic acids by hybridization, and arrays can be designed to define specific target sequences, analyze gene expression patterns or identify specific allelic variations. The arrays may be used for conducting cell study, for diagnosing disease, identifying gene expression, monitoring drug response, determination of viral load, identifying genetic polymorphisms, analyze gene expression patterns or identify specific allelic variations, and the like.

The synthesis of arrays of polynucleotides on the surface of a support usually involves attaching an initial nucleoside or nucleotide to a functionalized surface. The surface may be functionalized as discussed above. In one approach the surface is reacted with nucleosides or nucleotides that are also functionalized for reaction with the groups on the surface of the support. Methods for introducing appropriate amine specific or alcohol specific reactive functional groups into a nucleoside or nucleotide include, by way of example, addition of a spacer amine containing phosphoramidites, addition on the base of alkynes or alkenes using palladium mediated coupling, addition of spacer amine containing activated carbonyl esters, addition of boron conjugates, formation of Schiff bases.

After the introduction of the nucleoside or nucleotide onto the surface, the attached nucleotide may be used to construct the polynucleotide by means well known in the art. For example, in the synthesis of arrays of oligonucleotides, nucleoside monomers are generally employed. In this embodiment an array of the above compounds is attached to the surface and each compound is reacted to attach a nucleoside. Nucleoside monomers are used to form the polynucleotides usually by phosphate coupling, either direct phosphate coupling or coupling using a phosphate precursor such as a phosphite coupling. Such coupling thus includes the use of amidite (phosphoramidite), phosphodiester, phosphotriester, H-phosphonate, phosphite halide, and the like coupling.

One preferred coupling method is phosphoramidite coupling, which is a phosphite coupling. In using this coupling method, after the phosphite coupling is complete, the resulting phosphite is oxidized to a phosphate. Oxidation can be effected with iodine to give phosphates or with sulfur to give phosphorothioates. The phosphoramidites are dissolved in anhydrous acetonitrile to give a solution having a given ratio of amidite concentrations. The mixture of known chemically compatible monomers is reacted to a solid support, or further along, may be reacted to a growing chain of monomer units. In one particular example, the terminal 5′-hydroxyl group is caused to react with a deoxyribonucleoside-3′-O-(N,N-diisopropylamino)phosphoramidite protected at the 5′-position with dimethoxytrityl or the like. The 5′ protecting group is removed after the coupling reaction, and the procedure is repeated with additional protected nucleotides until synthesis of the desired polynucleotide is complete. For a more detailed discussion of the chemistry involved in the above synthetic approaches, see, for example, U.S. Pat. No. 5,436,327 at column 2, line 34, to column 4, line 36, which is incorporated herein by reference in its entirety.

Various ways may be employed to introduce the reagents for producing an array of polynucleotides on the surface of a support such as a glass support. Such methods are known in the art. One such method is discussed in U.S. Pat. No. 5,744,305 (Fodor, et al.) and involves solid phase chemistry, photolabile protecting groups and photolithography. Binary masking techniques are employed in one embodiment of the above. Arrays are fabricated in situ, adding one base pair at a time to a primer site. Photolithography is used to uncover sites, which are then exposed and reacted with one of the four base pair phosphoramidites. In photolithography the surface is first coated with a light-sensitive resist, exposed through a mask and the pattern is revealed by dissolving away the exposed or the unexposed resist and, subsequently, a surface layer. A separate mask is usually made for each pattern, which may involve four patterns for each base pair in the length of the probe.

Another in situ method employs inkjet printing technology to dispense the appropriate phosphoramidite reagents and other reagents onto individual sites on a surface of a support. Oligonucleotides are synthesized on a surface of a substrate in situ using phosphoramidite chemistry. Solutions containing nucleotide monomers and other reagents as necessary such as an activator, e.g., tetrazole, are applied to the surface of a support by means of thermal ink-jet technology. Individual droplets of reagents are applied to reactive areas on the surface using, for example, a thermal ink-jet type nozzle. The surface of the support may have an alkyl bromide trichlorosilane coating to which is attached polyethylene glycol to provide terminal hydroxyl groups. These hydroxyl groups provide for linking to a terminal primary amine group on a monomeric reagent. Excess of non-reacted chemical on the surface is washed away in a subsequent step. For example, see U.S. Pat. No. 5,700,637 and PCT WO 95/25116 and PCT application WO 89/10977.

Another approach for fabricating an array of biopolymers on a substrate using a biopolymer or biomonomer fluid and using a fluid dispensing head is described in U.S. Pat. No. 6,242,266 (Schleifer, et al.). The head has at least one jet that can dispense droplets onto a surface of a support. The jet includes a chamber with an orifice and an ejector, which, when activated, causes a droplet to be ejected from the orifice. Multiple droplets of the biopolymer or biomonomer fluid are dispensed from the head orifice so as to form an array of droplets on the surface of the substrate.

In another embodiment (U.S. Pat. No. 6,232,072) (Fisher) a method of, and apparatus for, fabricating a biopolymer array is disclosed. Droplets of fluid carrying the biopolymer or biomonomer are deposited onto a front side of a transparent substrate. Light is directed through the substrate from the front side, back through a substrate back side and a first set of deposited droplets on the first side to an image sensor.

An example of another method for chemical array fabrication is described in U.S. Pat. No. 6,180,351 (Cattell). The method includes receiving from a remote station information on a layout of the array and an associated first identifier. A local identifier is generated corresponding to the first identifier and associated array. The local identifier is shorter in length than the corresponding first identifier. The addressable array is fabricated on the substrate in accordance with the received layout information.

Other methods for synthesizing arrays of oligonucleotide on a surface include those disclosed by Gamble, et al., WO97/44134; Gamble, et al., WO98/10858; Baldeschwieler, et al., WO95/25116; Brown, et al., U.S. Pat. No. 5,807,522; and the like.

In general, in the above synthetic steps involving monomer addition such as, for example, the phosphoramidite method, there are certain repetitive steps such as washing the surface of the support prior to or after a reaction, oxidation of substances such as oxidation of a phosphite group to a phosphate group, removal of protecting groups, blocking of sites to prevent reaction at such site, capping of sites that did not react with a phosphoramidite reagent, deblocking, and so forth. In addition, under certain circumstances other reactions may be carried out in a flow cell such as, for example, phosphoramidite monomer addition, modified phosphoramidite addition, other monomer additions, addition of a polymer chain to a surface for linking to monomers, and so forth.

For in situ fabrication methods, multiple different reagent droplets are deposited by pulse jet or other means at a given target location in order to form the final feature (hence a probe of the feature is synthesized on the array substrate). The in situ fabrication methods include those described in U.S. Pat. No. 5,449,754 for synthesizing peptide arrays, and in U.S. Pat. No. 6,180,351 and WO 98/41531 and the references cited therein for polynucleotides, and may also use pulse jets for depositing reagents. The in situ method for fabricating a polynucleotide array typically follows, at each of the multiple different addresses at which features are to be formed, the same conventional iterative sequence used in forming polynucleotides from nucleoside reagents on a support by means of known chemistry. This iterative sequence can be considered as multiple ones of the following attachment cycle at each feature to be formed: (a) coupling an activated selected nucleoside (a monomeric unit) through a phosphite linkage to a functionalized support in the first iteration, or a nucleoside bound to the substrate (i.e. the nucleoside-modified substrate) in subsequent iterations; (b) optionally, blocking unreacted hydroxyl groups on the substrate bound nucleoside (sometimes referenced as “capping”); (c) oxidizing the phosphite linkage of step (a) to form a phosphate linkage; and (d) removing the protecting group (“deprotection”) from the now substrate bound nucleoside coupled in step (a), to generate a reactive site for the next cycle of these steps.

The coupling can be performed by depositing drops of an activator and phosphoramidite at the specific desired feature locations for the array. Capping, oxidation and deprotection can be accomplished by treating the entire substrate (“flooding”) with a layer of the appropriate reagent. The functionalized support (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in another flooding procedure in a known manner. Conventionally, a single pulse jet or other dispenser is assigned to deposit a single monomeric unit.

The foregoing chemistry of the synthesis of polynucleotides is described in detail, for example, in Caruthers, Science 230: 281-285, 1985; Itakura, et al., Ann. Rev. Biochem. 53: 323-356; Hunkapillar, et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. Nos. 4,458,066, 4,500,707, 5,153,319, 5,869,643 and European patent application, EP 0294196, and elsewhere. The phosphoramidite and phosphite triester approaches are most broadly used, but other approaches include the phosphodiester approach, the phosphotriester approach and the H-phosphonate approach. The substrates are typically functionalized to bond to the first deposited monomer. Suitable techniques for functionalizing substrates with such linking moieties are described, for example, in Southern, E. M., Maskos, U. and Elder, J. K., Genomics, 13, 1007-1017, 1992.

In the case of array fabrication, different monomers and activator may be deposited at different addresses on the substrate during any one cycle so that the different features of the completed array will have different desired biopolymer sequences. One or more intermediate further steps may be required in each cycle, such as the conventional oxidation, capping and washing steps in the case of in situ fabrication of polynucleotide arrays. Again, these steps may be performed in flooding procedure.

The focus of the method of the present invention are those steps that are performed using flow cells, which may be dedicated flow cells, i.e., a flow cell for each separate distinct step. Accordingly, for example, after addition of a nucleoside monomer, whether using an ink jet method, a photolithography method or the like, the support is placed into a chamber of a flow cell. Typically, the flow cell is a housing having a reaction cavity or chamber disposed therein. The flow cell allows fluids to be passed through the chamber where the support is disposed. The support is mounted in the chamber in or on a holder. The housing usually further comprises at least one fluid inlet and at least one fluid outlet for flowing fluids into and through or out of the chamber in which the support is mounted.

The housing of the flow cell is generally constructed to permit access into the chamber therein. In one approach, the flow cell has an opening that is sealable to fluid transfer after the support is placed therein. Such seals may comprise a flexible material that is sufficiently flexible or compressible to form a fluid tight seal that can be maintained under increased pressures encountered in the use of the device. The flexible member may be, for example, rubber, flexible plastic, flexible resins, and the like and combinations thereof. In any event the flexible material should be substantially inert with respect to the fluids introduced into the device and must not interfere with the reactions that occur within the device. The flexible member is usually a gasket and may be in any shape such as, for example, circular, oval, rectangular, and the like. Preferably, the flexible member is in the form of an O-ring.

In another approach the housing of the flow cell may be conveniently constructed in two parts, which may be referred to generally as top and bottom elements. These two elements are sealably engaged during synthetic steps and are separable at other times to permit the support to be placed into and removed from the chamber of the flow cell. Generally, the top element is adapted to be moved with respect to the bottom element although other situations are contemplated herein. Movement of the top element with respect to the bottom element is achieved by means of, for example, pistons, and so forth. The movement is controlled electronically by means that are conventional in the art. In another approach a reagent chamber is formed in situ from a support and a sealing member.

The inlet of the flow cell is usually in fluid communication with an element that controls the flow of fluid into the flow cell such as, for example, a manifold, a valve, and the like or combinations thereof. This element in turn is in fluid communication with one or more fluid reagent dispensing stations. In this way different fluid reagents for one step in the synthesis of the chemical compound may be introduced sequentially into the flow cell. These reagents may be, for example, a chemical reagent that forms part of the chemical compound by addition thereto, wash fluids, oxidizing agents, reducing agents, blocking or protecting agents, unblocking (deblocking) or deprotecting agents, and so forth. Any reagent that is normally a solid reagent may be converted to a fluid reagent by dissolution in a suitable solvent, which may be a protic solvent or an aprotic solvent. The solvent may be an organic solvent such as, by way of illustration and not limitation, oxygenated organic solvents of from 1 to about 6, more usually from 1 to about 4, carbon atoms, including alcohols such as methanol, ethanol, propanol, etc., ethers such as tetrahydrofuran, ethyl ether, propyl ether, etc., acetonitrile, dimethylformamide, dimethylsulfoxide, and the like. The solvent may be an aqueous medium that is solely water or may contain a buffer, or may contain from about 0.01 to about 80 or more volume percent of a cosolvent such as an organic solvent as mentioned above.

In one embodiment the fluid dispensing stations are affixed to a base plate or main platform to which the flow cells are mounted. Any fluid dispensing station may be employed that dispenses fluids such as water, aqueous media, organic solvents and the like. The fluid dispensing station may comprises a pump for moving fluid and may also comprise a valve assembly and a manifold as well as a means for delivering predetermined quantities of fluid to the flow cell. The fluids may be dispensed by pumping from the dispensing station. In this regard any standard pumping technique for pumping fluids may be employed in the present apparatus. For example, pumping may be by means of a peristaltic pump, a pressurized fluid bed, a positive displacement pump, e.g., a syringe pump, and the like.

After the reagent in introduced into the flow cell, the reagent is held in contact with the support for a time and under conditions sufficient for the particular step to be completed. The time periods and conditions are dependent on the nature of the reagent and the nature of the particular step of the procedure. For example, the time periods and conditions may be different for a washing procedure rather than an oxidizing reaction or a deblocking reaction. In general, the time periods and conditions for the procedures conducted in the flow cells are well-known in the art and will not be repeated here.

In one approach in accordance with the present methods, the fluid outlet or inlet of a flow cell may be used to vent the interior of the reaction chamber while a vacuum is applied to whichever of the inlet or outlet is not used for venting. For example, the fluid outlet may be used for the vent and vacuum applied to the fluid inlet. On the other hand, fluids may be removed from the reaction chamber by means of the outlet, to which the vacuum is applied, with the inlet serving as a vent.

The vacuum applied is usually that sufficient to remove the fluid from the interior of the chamber of the flow cell so that the pressure inside the chamber does not significantly exceed atmospheric pressure. By the term “substantially exceed” is meant that the pressure in the chamber does not exceed atmospheric pressure by more than 12%, usually, 6%. The fluid is generally removed at a rate of about 0.5 to about 3 ml/second, usually, about 1 to about 1.5 ml/second. The parameters for the vacuum are adjusted to achieve the aforementioned flow rate for removal of the fluid. The inlet, or the outlet, to which the vacuum is applied is connected by standard means to a source of the vacuum. The vacuum source may be, for example, a vacuum pump, venturi and the like. As a result of the present method, fluid is removed from the flow cell without visible evidence of pockets of residual fluid remaining in the flow cell. This assists in reducing the amount of time for drying of the surface of the support. As a result of the present invention, the drying time is reduced by at least about 10%, usually, at least about 20% over that observed in the absence of the present method. Accordingly, the drying time for supports that have been the subject of the present methods is about 160 to about 180 seconds, usually, about 140 to about 160 seconds

Alternatively, after the fluid is removed from the flow cell in accordance with the above method, an inert pressurized gas is introduced into the flow cell while a vacuum is applied to the flow cell. In this way, drying time is further reduced. The pressure of the inert gas is about 3 to about 10 psi, usually, about 4 to about 6 psi. The pressurized gas is applied for a period sufficient to dry the surface of the support. Usually, the time period for this step is about 60 to about 90 seconds, more usually, about 70 to about 80 seconds. As a result of this aspect of the present invention, the drying time is reduced at least about 60%, usually, at least about 40% over that observed in the absence of the present method. Accordingly, the drying time for supports that have been the subject of this aspect of the present methods is about 105 to about 120 seconds, usually, about 70 to about 80 seconds.

After the fluid has been removed from the flow cell, the support may be removed and subjected to the next step of the synthetic process, which may be carried out in the reaction chamber or in another flow cell. For example, upon completion of the first step in the synthesis of the chemical compound, the support is removed from the first flow cell and transferred to a second flow cell, which generally has the same or similar configuration as the first flow cell but need not. The support is transported between reaction sites, e.g., reaction chamber, flow cell, etc., by a transfer element such as a robotic arm, and so forth. In one embodiment a transfer robot is mounted on the main platform of an apparatus for carrying out the syntheses on the surfaces of the supports.

The transfer robot may comprise a base, an arm that is movably mounted on the base, and an element for grasping the support during transport that is attached to the arm. The element for grasping the support may be, for example, movable finger-like projections, and the like. In use, the robotic arm is activated so that the support is grasped by the above-mentioned element. The arm of the robot is moved so that the support is delivered to a predetermined location such as a reaction chamber or flow cell or the like, which is in the open position so that the support is delivered into the chamber thereof.

It is often the case in syntheses of chemical compounds on the surface of a support that one or more steps in the synthesis process is a repeat of an earlier step because the chemical component that is to be added to the growing molecule is the same as that in a previous step. In this instance the transfer element delivers the support to a flow cell in which the earlier repetitive step was carried out and at which the dispensing stations have the necessary reagents for conducting this step.

The amount of the reagents employed in each synthetic step in the method of the present invention is dependent on the nature of the reagents, solubility of the reagents, reactivity of the reagents, availability of the reagents, purity of the reagents, and so forth. Such amounts should be readily apparent to those skilled in the art in view of the disclosure herein. Usually, stoichiometric amounts are employed, but excess of one reagent over the other may be used where circumstances dictate. Typically, the amounts of the reagents are those necessary to achieve the overall synthesis of the chemical compound in accordance with the present invention. The time period for conducting the present method is dependent upon the specific reaction and reagents being utilized and the chemical compound being synthesized.

The present invention may be described further using as an example the synthesis of polynucleotides on a surface of a support by the phosphoramidite method. This description is by way of illustration and not limitation. The step of oxidation of phosphite to phosphate is carried out in a flow cell. Accordingly, following addition of a monomer, the support is placed in the flow cell, which is then closed to form a liquid tight seal. Various fluid dispensing stations are connected by means of a manifold and suitable valves and manifold to the inlet of the flow cell. Each of the fluid dispensing stations contains a different fluid reagent involved in performing the particular synthetic addition of monomer. Thus, in this example, one station may contain an oxidizing agent for oxidizing the phosphite to the phosphate and another station may contain a wash reagent such as acetonitrile.

The wash reagent is first allowed to pass into the flow cell. After the requisite period of time for the wash step, which is usually about 10 to about 60 seconds, a vacuum is applied to the outlet of the flow cell, with the inlet employed as a vent, to remove the wash reagent. Next, oxidizing agent is allowed to pass into the flow cell. The oxidizing agent is held in the flow cell for the required period of time, which is usually about 10 to about 60 seconds. Then, a vacuum is applied to the outlet of the flow cell, with the inlet employed as a vent, to remove the oxidizing agent. The surface is again washed with the wash reagent with liquid removal as described above. Subsequent to this second wash step, pressurized inert gas is introduced into the flow cell by means of the inlet with a vacuum applied to the outlet in order to assist in drying the surface of the support.

In this example, the support is then transported from the oxidizing flow cell to another flow cell where the support is treated with a deblocking reagent for removing a protecting group. The deblocking reagent is allowed to pass into the second flow cell. The deblocking reagent is contained in a fluid dispensing station that is in fluid communication with the second flow cell. As in the case with the oxidizing reagent, the deblocking agent is held in contact with the support for the requisite period of time. The wash reagent is first allowed to pass into the flow cell. After the requisite period of time for the wash step, which is usually about 10 to about 60 seconds, a vacuum is applied to the outlet of the flow cell, with the inlet employed as a vent, to remove the wash reagent. Next, oxidizing agent is allowed to pass into the flow cell. The oxidizing agent is held in the flow cell for the required period of time, which is usually about 10 to about 60 seconds. Then, a vacuum is applied to the outlet of the flow cell, with the inlet employed as a vent, to remove the oxidizing agent. The surface is again washed with the wash reagent with liquid removal as described above. Subsequent to this second wash step, pressurized inert gas is introduced into the flow cell by means of the inlet with a vacuum applied to the outlet in order to assist in drying the surface of the support.

Then, a vacuum is applied to the outlet of the flow cell, with the inlet employed as a vent, to remove the oxidizing agent. The surface is washed with wash reagent with liquid removal as described above. Subsequent to this second wash step, pressurized inert gas is introduced into the flow cell by means of the inlet with a vacuum applied to the outlet in order to assist in drying the surface of the support.

Following the above synthetic steps, the support is transported from the second flow cell to a station where the next monomer addition is carried out and the above repetitive synthetic steps are conducted as discussed above.

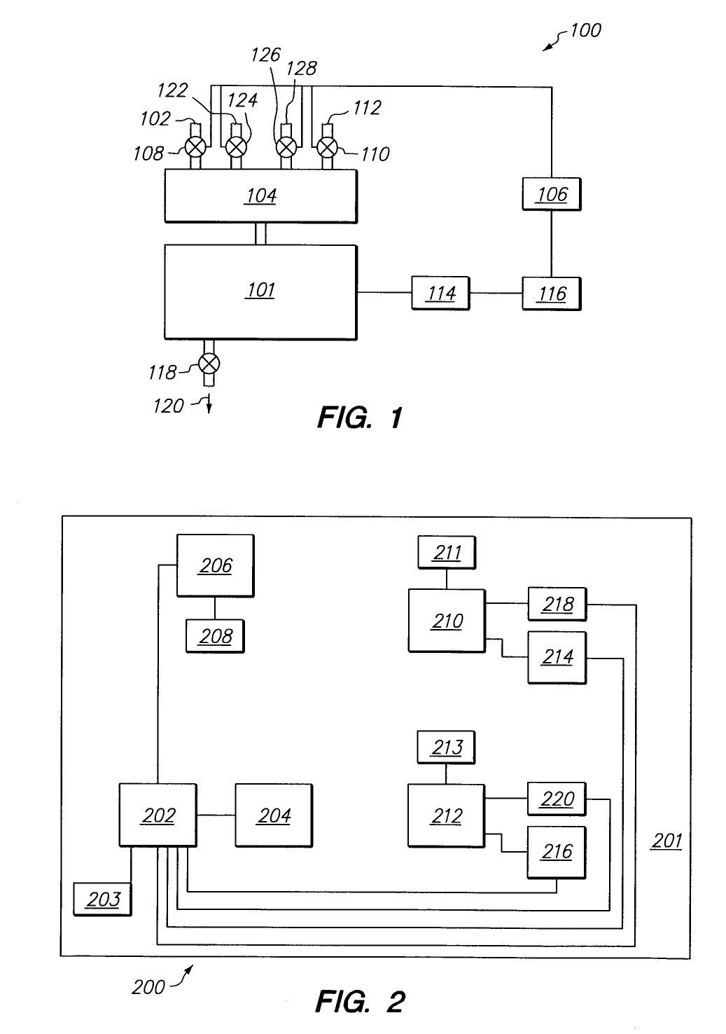

The following discussion is by way of illustration and not limitation. Referring to FIG. 1 a flow cell assembly 100 is depicted in which one step in the synthesis of an array of polynucleotides is carried out. As mentioned above, one such step involves the oxidation of a phosphite group to a phosphate group. After a monomer addition step, a support on which the array is synthesized is placed into the interior of flow cell 101 and a wash reagent 102 (acetonitrile in this example) is introduced into flow cell 101 by means of manifold 104 and valve 108. Controller 106 directs valve 108 and valve 110 to open. Valve 110 opens to vent 112 and vents flow cell 101 during the entry of wash reagent 102 into flow cell 101. Sensor 114 senses when flow cell 101 is filled and communicates a signal to computer 116, which directs the controller to close valve 108 and valve 110. After the requisite amount of time for the wash step, valve 118 is activated to open to vacuum 120 and valve 110 is also opened. Vacuum 120 is applied to flow cell 101 to remove wash reagent. Sensor 114 senses that flow cell 101 is empty and sensor 114 communicates a signal to computer 116, which directs the controller to close valve 118 and valve 110. The closing of valve 118 may be delayed for a predetermined period of time so that vacuum may be applied after the bulk of the liquid has been evacuated to further remove residual liquid.

Next, an oxidizing reagent 120 is introduced into flow cell 101 by means of manifold 104 and valve 122. A controller (not shown) directs valve 122 and valve 110 to open. Valve 110 opens to vent 112 and vents flow cell 100 during the entry of oxidizing reagent 120 into flow cell 101. Sensor 114 senses when flow cell 100 is filled and communicates a signal to computer 116, which directs the controller to close valve 122 and valve 110. After the requisite amount of time for the oxidation step, valve 118 is activated to open to vacuum 120 and valve 110 is also opened. Vacuum 120 is applied to flow cell 101 to remove oxidizing reagent. Sensor 114 senses that flow cell 101 is empty and sensor 114 communicates a signal to computer 116, which directs the controller to close valve 118 and valve 110. Again, the closing of valve 118 may be delayed for a predetermined period of time so that vacuum may be applied after the bulk of the liquid has been evacuated to further remove residual liquid.

Following the oxidation step, the support is again washed as described above. At the end of this wash step, valve 118 remains open after the closing of valve 110 and the controller directs valve 126 to open to admit pressurized inert gas 128. Gas 128 is applied to flow cell 101 for a predetermined amount of time to remove residual liquid from the surface of the support and from flow cell 101. Then, the controller closes valve 126 and valve 110. The support is either subjected to a next step of the synthesis in flow cell 101 or removed from flow cell 101 and placed in another flow cell where it is subjected to the next step in the synthesis, namely, a deblocking step of the aforementioned monomer addition synthesis. The procedure followed for the deblocking step is similar to that described above for the oxidizing step with the exception that a deblocking reagent is employed in place of an oxidizing reagent. Subsequent to the deblocking step, the support is removed and placed in a reaction chamber for the next monomer addition.

Another embodiment of the present invention is an apparatus for synthesizing an array of biopolymers on the surface of a support. The apparatus comprises a platform and a plurality of flow cell assemblies mounted on the platform. The flow cell assemblies are as described above. One or more fluid dispensing stations are mounted on the platform and are in fluid communication with one or more of the plurality of flow cell assemblies. A station for monomer addition to the surface of the support is mounted on the platform. The apparatus also comprises a mechanism for moving a support to and from the station for monomer addition and a flow cell and from one flow cell to another flow cell. The mechanism may be, for example, a robotic arm, and so forth.

In one embodiment of a mechanism for moving a support from one flow cell to another flow cell, the support is delivered into the opening in the wall of the flow cell housing by engagement with a holding element, which usually comprises a main arm and an end portion that contacts and engages a surface of the support. In one embodiment the holding element is in the form of a fork that is vacuum activated. Other embodiments of the holding element include, for example, grasping elements such as movable finger-like projections, and the like. The holding element is usually part of a transfer robot that comprises a robotic arm that is capable or transferring the support from various positions where steps in the synthesis of the chemical compound are performed such as between several flow devices in accordance with the present invention. In one embodiment a transfer robot is mounted on the main platform. The transfer robot may comprise a base, an arm that is movably mounted on the base, and an element for holding the support during transport that is attached to the arm. Also included is a controller for controlling the movement of the transfer mechanism.

One embodiment of an apparatus that comprises one or more flow cell assemblies in accordance with the present invention is depicted in FIG. 2 in schematic form. Apparatus 200 comprises platform 201 on which the components of the apparatus are mounted. Apparatus 200 comprises main computer 202 (which corresponds to computer 116 of FIG. 1), with which various components of the apparatus are in communication. Video display 203 is in communication with computer 202. Apparatus 200 further comprises print chamber 204, which is controlled by main computer 202. The nature of print chamber 204 depends on the nature of the printing technique employed to add monomers to a growing polymer chain. Such printing techniques include, by way of illustration and not limitation, inkjet printing, and so forth. Transfer robot 206 is also controlled by main computer 202 and comprises a robot arm 208 that moves a support to be printed from print chamber 204 to either first flow cell assembly 210 or second flow cell assembly 212. In one embodiment robot arm 208 introduces a support into print chamber 204 horizontally for printing on a surface of the support and introduces the support into a flow cell vertically. First flow cell assembly 210 is in communication with program logic controller 214 (which corresponds to controller 106 of FIG. 1), which is controlled by main computer 202, and second flow cell 212 is in communication with program logic controller 216 (which corresponds to controller 106 of FIG. 1), which is also controlled by main computer 202. First flow cell 210 assembly is in communication with fluid dispensing station 211 and flow sensor and level indicator 218 (which corresponds to sensor 114 of FIG. 1), which are controlled by main computer 202, and second flow cell assembly 212 is in communication with fluid dispensing station 213 and flow sensor and level indicator 220 (which corresponds to sensor 114 of FIG. 1), which are also controlled by main computer 202.

The apparatus of the invention further comprise appropriate electrical and mechanical architecture and electrical connections, wiring and devices such as timers, clocks, and so forth for operating the various elements of the apparatus. Such architecture is familiar to those skilled in the art and will not be discussed in more detail herein.

The methods in accordance with the present invention may be carried out under computer control, that is, with the aid of a computer. For example, an IBM® compatible personal computer (PC) may be utilized. The computer is driven by software specific to the methods described herein. A preferred computer hardware capable of assisting in the operation of the methods in accordance with the present invention involves a system with at least the following specifications: Pentium® processor or better with a clock speed of at least 100 MHz, at least 32 megabytes of random access memory (RAM) and at least 80 megabytes of virtual memory, running under either the Windows 95 or Windows NT 4.0 operating system (or successor thereof). Software that may be used to carry out the methods may be, for example, Microsoft Excel or Microsoft Access, suitably extended via user-written functions and templates, and linked when necessary to stand-alone programs. Examples of software or computer programs used in assisting in conducting the present methods may be written, preferably, in Visual BASIC, FORTRAN and C⁺⁺. It should be understood that the above computer information and the software used herein are by way of example and not limitation. The present methods may be adapted to other computers and software. Other languages that may be used include, for example, PASCAL, PERL or assembly language.

A computer program may be utilized to carry out the above method steps. The computer program provides for, among others, (i) placing a support into a chamber of a first flow assembly in accordance with the present invention, (ii) introducing a fluid reagent for conducting a reaction step into the reagent chamber, (iii) removing the fluid reagent from the reagent chamber under vacuum while venting the chamber, (iv) removing the support from the housing chamber, (v) placing the support into a chamber of a second flow assembly in accordance with the present invention, (vi) introducing a fluid reagent for conducting a reaction step into the reagent chamber, (vii) removing the fluid reagent from the reagent chamber under vacuum while venting the chamber, and (viii) removing the support from the housing chamber. The computer program provides for controlling the valves of the flow assemblies to introduce reagents into the flow cells, vent the flow cells, apply a vacuum to the flow cells, optionally, introduce pressurized gas into the flow cell, and so forth. The computer program further may provide for moving the support to and from a station for monomer addition at a predetermined point in the aforementioned method.

Another aspect of the present invention is a computer program product comprising a computer readable storage medium having a computer program stored thereon which, when loaded into a computer, performs the aforementioned method.

Following receipt by a user of an array made by an apparatus or method of the present invention, it will typically be exposed to a sample (for example, a fluorescent-labeled polynucleotide or protein containing sample) and the array is then read. Reading of the array may be accomplished by illuminating the array and reading the location and intensity of resulting fluorescence at each feature of the array. For example, a scanner may be used for this purpose where the scanner may be similar to, for example, the AGILENT MICROARRAY SCANNER available from Agilent Technologies Inc, Palo Alto, Calif. Other suitable apparatus and methods are described in U.S. patent applications: Ser. No. 09/846,125“Reading Multi-Featured Arrays” by Dorsel, et al.; and Ser. No. 09/430,214“Interrogating Multi-Featured Arrays” by Dorsel, et al. The relevant portions of these references are incorporated herein by reference. However, arrays may be read by methods or apparatus other than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

When one item is indicated as being “remote” from another, this is referenced that the two items are at least in different buildings, and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

All publications and patent applications cited in this specification are herein incorporated by reference as if each individual publication or patent application were specifically and individually indicated to be incorporated by reference.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A method for synthesizing a plurality of biopolymers on the surface of a support, said method comprising:
(a) placing said support into a reaction chamber and applying to said surface said biopolymers or precursors of said biopolymers,
(b) removing said support from said reaction chamber and placing said support into a flow chamber,
(c) introducing a liquid reagent for conducting said synthesis into said flow chamber,
(d) removing said liquid reagent from said flow chamber wherein the pressure in said chamber is maintained substantially atmospheric during said removing.
(e) removing said support from said flow chamber and
(f) repeating steps (a)-(e) to form said plurality of biopolymers on the surface of said support.

2. A method according to claim 1 wherein liquid reagent is removed from said flow chamber under vacuum.

3. A method according to claim 1 wherein liquid reagent is removed from said flow chamber by simultaneously venting and applying a vacuum to said flow chamber.

4. A method according to claim 3 wherein said venting and said applying a vacuum are carried out at opposite ends of said flow chamber.

5. A method according to claim 1 wherein said method further comprises holding said liquid reagent in said flow chamber for a predetermined period of time.

6. A method according to claim 1 wherein said support is glass.

7. A method according to claim 1 further comprising introducing a pressurized inert gas into said flow chamber after step (c) and simultaneously evacuating said flow chamber.

8. A method according to claim 1 wherein said biopolymers are polynucleotides.

9. A method according to claim 1 wherein said liquid reagent for conducting said synthesis comprises an oxidizing agent or an agent for removing a protecting group.

10. A method according to claim 1 wherein said biopolymers are synthesized on said surface in multiple arrays and said support is subsequently diced into individual arrays of biopolymers on a support.

11. A method according to claim 10 further comprising exposing the array to a sample and reading the array.

12. A method according to claim 11 comprising forwarding data representing a result obtained from a reading of the array.

13. A method according to claim 12 wherein the data is transmitted to a remote location.

14. A method according to claim 13 comprising receiving data representing a result of an interrogation obtained by the reading of the array.

15. A method for synthesizing an array of biopolymers on the surface of a support wherein said synthesis comprises a plurality of monomer additions, said method comprising after each of said monomer additions:
(a) placing said support into a flow chamber,
(c) introducing a liquid reagent for conducting said synthesis into said flow chamber,
(d) removing said reagent from said flow chamber by simultaneously venting said chamber and applying a vacuum to the interior of said chamber,
(e) removing said support from said flow chamber and
(f) repeating steps (a)-(e) to form said plurality of biopolymers on the surface of said support.

16. A method according to claim 15 wherein said venting and said applying a vacuum are carried out at opposite ends of said flow chamber.

17 A method according to claim 15 wherein said method further comprises holding said liquid reagent in said flow chamber for a predetermined period of time.

18. A method according to claim 15 wherein said support is glass.

19. A method according to claim 15 further comprising introducing a pressurized inert gas into said flow chamber after step (d) and simultaneously evacuating said flow chamber.

20. A method according to claim 15 wherein said biopolymers are polynucleotides.

21. A method according to claim 15 wherein said liquid reagent for conducting said synthesis is an oxidizing agent or an agent for removing a protecting group.

22. A method according to claim 15 wherein said biopolymers are synthesized on said surface in multiple arrays and said support is subsequently diced into individual arrays of biopolymers on a support.

23. A flow cell assembly for conducting at least one reaction in the synthesis of an array of biopolymers on the surface of a support, said flow cell comprising:
(a) a flow cell chamber,
(b) a manifold in fluid communication with said chamber, said manifold comprising at least a wash reagent inlet, an inlet for a reagent for conducting a step of said synthesis, and a vent, and
(c) a vacuum source in fluid communication with said flow cell chamber.

24. A flow cell assembly according to claim 23 further comprising a fluid level sensor and a controller for controlling said inlets, said vent and said vacuum source.

25. A flow cell assembly according to claim 23 further comprising a gas inlet.

26. An apparatus for synthesizing an array of biopolymers on the surface of a support, said apparatus comprising:
(a) one or more flow cell assemblies of claim 23,
(b) one or more fluid dispensing stations in fluid communication with one or more of said plurality of flow cell assemblies,
(c) a station for monomer addition to said surface of said support, and
(d) a mechanism for moving a support to and from said station for monomer addition and a flow cell and from one flow cell to another flow cell.

27. An apparatus according to claim 26 further comprising a controller for controlling the movement of said mechanism.

28. An apparatus according to claim 26 wherein said mechanism is a robotic arm.

29. A method comprising using an array, prepared by an apparatus according to claim 26, by exposing the array to a sample and reading the array.

30. A method according to claim 29 comprising forwarding data representing a result obtained from a reading of the array.

31. A method according to claim 30 wherein the data is transmitted to a remote location.

32. A method according to claim 31 comprising receiving data representing a result of an interrogation obtained by the reading of the array.
